(19) United States
(12) Patent Application Publication
(10) Pub. No.: US 2018/0081442 A1
(43) Pub. Date: Mar. 22, 2018

(54) PRESSING FEEDBACK DEVICE, DISPLAY DEVICE AND CONTROL METHOD THEREOF

(71) Applicants: BOE TECHNOLOGY GROUP CO., LTD., Beijing (CN); CHENGDU BOE OPTOELECTRONICS TECHNOLOGY CO., LTD., Chengdu (CN)

(72) Inventors: Yuanjie XU, Beijing (CN); Pengcheng ZANG, Beijing (CN)

(21) Appl. No.: 15/678,320

(22) Filed: Aug. 16, 2017

(30) Foreign Application Priority Data
Sep. 21, 2016 (CN) 201610836639.2

(51) Int. Cl. G06F 3/01; G06F 3/041; G06F 3/0481; G06F 3/0488

(52) U.S. Cl. CPC G06F 3/016; G06F 3/0414; G06F 2203/04105; G06F 3/0488; G06F 3/04812

(57) ABSTRACT

A pressing feedback device, a display device and a control method are provided. The pressing feedback device includes a pressing portion having a pressing surface; and at least one deformation light-emitting portion located under the pressing portion and configured to be deformed under pressing of the pressing portion when the pressing surface is subjected to a pressure, wherein the pressure to which the pressing portion is subjected can be transferred to the deformation light-emitting portion, wherein the deformation light-emitting portion does not emit light before deformation, and emits light after deformation.

### CROSS-REFERENCE TO RELATED APPLICATIONS

The present application claims priority to Chinese Patent Application No. 201610836639.2, filed Sep. 21, 2016, the entire contents of which are incorporated herein by reference.

### TECHNICAL FIELD

The present disclosure relates to the field of display technology, and more particularly, to a pressing feedback device, a display device, and a control method thereof.

### BACKGROUND

With the increasing popularity of mobile devices, the human-computer communication of a variety of electronic products, such as tablet PCs, mobile phones, wearable equipment or the like, has become increasingly important. At present, in the mainstream touch, voice, iris, somatosensory and other interactive ways, the touch has advantages of handiness, quick response, space saving and so on, thus it becomes the best way to develop the future interaction. At present, touch feedback has become a hotspot of touch technology, which can provide users with timely and accurate touch confirmation and can further provide an intuitive tactile presentation, the complexity of touch feedback can be reduced, thereby enhancing the experience quality for the user.

In the prior art, there are two techniques for implementing touch feedback, i.e. vibration touch feedback and voice touch feedback. The development of vibration touch feedback technology and voice touch feedback technology is relatively mature. When the user performs a touch, a screen provides a shock and sound feedback to the user, such that the user obtains a touch confirmation feedback. This technology is mostly applied in mobile phones, tablets and other hardware applications.

However, voice touch feedback is not suitable for use in some public places because of its lack of privacy. In addition, voice touch feedback and vibration touch feedback may generate voice, which may result that they are not suitable for use in quiet occasions, and the sound or vibration mode is not convenient enough in some noisy occasions, such as shopping malls, bars and other places, thus reducing the experience of the human-computer interaction.

### SUMMARY

An embodiment of the present disclosure provides a pressing feedback device, a display device and a control method thereof, which can be used for optical signal feedback when being pressed.

In a first aspect, a pressing feedback device is provided, including a pressing portion having a pressing surface; and at least one deformation light-emitting portion located under the pressing portion and configured to be deformed under pressing of the pressing portion when the pressing surface is subjected to a pressure, wherein the pressure to which the pressing portion is subjected can be transferred to the deformation light-emitting portion, wherein the deformation light-emitting portion does not emit light before deformation, and emits light after deformation, or the deformation light-emitting portion emits light of a color before deformation, and emits light of another color after deformation.

In a second aspect, a display device is provided, including the pressing feedback device described as above.

In a third aspect, a driving method of a display device including the pressing feedback device described as above, including: charging, by the charging unit, the capacitor unit; after the charging of the capacitor unit is finished, detecting, by the control unit, a voltage value between the first electrode and the second electrode of the capacitor unit; and when the voltage value between the first electrode and the second electrode of the capacitor unit is changed to the predetermined voltage value control unit, inputting, by the control unit, the driving signal to the electroluminescent layer.

### BRIEF DESCRIPTION OF THE DRAWINGS

In order to more clearly illustrate the technical solution in the embodiments of the present disclosure or in the related art, the drawings, which are intended to be used in the description of the embodiments or of the related art, will be briefly described below. It will be apparent that the drawings in the following description are merely examples of the present disclosure, and other drawings may be obtained by those skilled in the art without making creative effort.

FIG. 1 is a structural schematic diagram of a pressing feedback device according to an embodiment of the present disclosure;

FIG. 2 is another structural schematic diagram of a pressing feedback device according to an embodiment of the present disclosure;

FIG. 3 is yet another structural schematic diagram of a pressing feedback device according to an embodiment of the present disclosure;

FIG. 4A is still another structural schematic diagram of a pressing feedback device according to an embodiment of the present disclosure;

FIG. 4B is still another structural schematic diagram of a pressing feedback device according to an embodiment of the present disclosure;

FIG. 4C is still another structural schematic diagram of a pressing feedback device according to an embodiment of the present disclosure;

FIG. 5 is a structural schematic diagram of a display device according to an embodiment of the present disclosure;

FIG. 6 is another structural schematic diagram of a display device according to an embodiment of the present disclosure;

FIG. 7A is a schematic diagram of a structure in which a display region of a display device includes a plurality of sub-display regions according to an embodiment of the present disclosure;

FIG. 7B is another schematic diagram of a structure in which a display region of a display device includes a plurality of sub-display regions according to an embodiment of the present disclosure;

FIG. 8 is yet another structural schematic diagram of a display device according to an embodiment of the present disclosure; and

FIG. 9 is a schematic flow chart of a driving method of a display device including the pressing feedback device according to an embodiment of the present disclosure.

### DETAILED DESCRIPTION

The technical solutions in the embodiments of the present disclosure will be described clearly and thoroughly in conjunction with the accompanying drawings in the embodiments of the present disclosure. Apparently, the described embodiments are merely part of the embodiments of the present disclosure and are not all of the embodiments of the present disclosure. Based on embodiments in the present disclosure, all other embodiments obtained by those of ordinary skill in the art without making creative effort fall within the scope of the present disclosure.

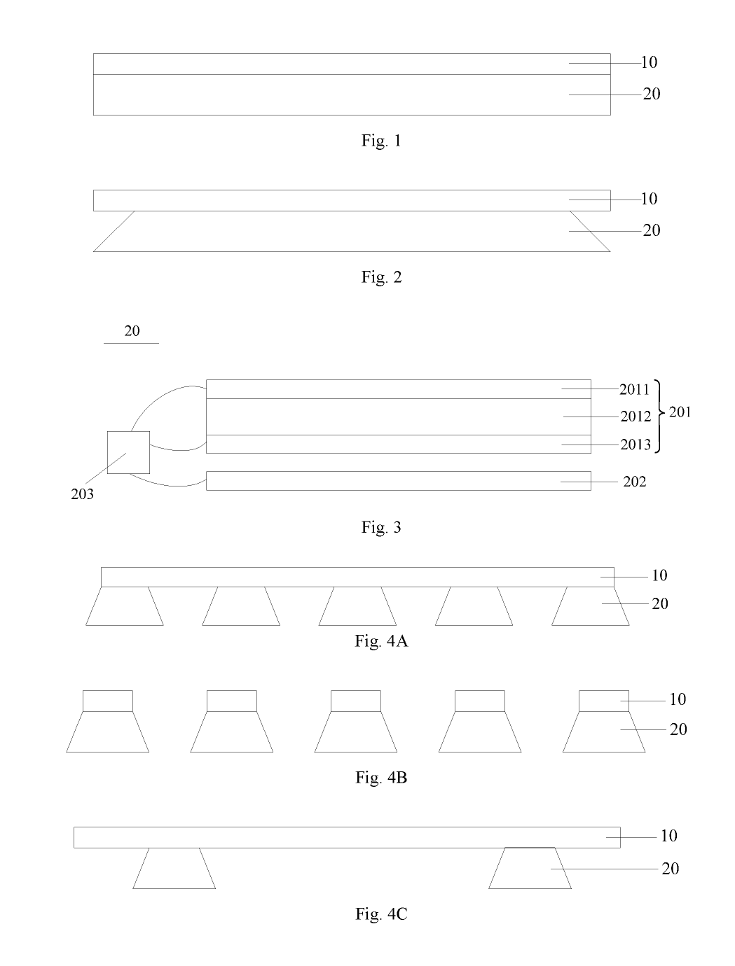

An embodiment of the present disclosure provides a pressing feedback device. As shown in FIG. 1, the pressing feedback device includes a pressing portion 10 having a pressing surface and at least one deformation light-emitting portion 20. The deformation light-emitting portion 20 is located under the pressing portion 10 and configured to be deformed under pressing of the pressing portion 10 when the pressing surface is subjected to a pressure, wherein the pressure to which the pressing portion 10 is subjected can be transferred to the deformation light-emitting portion 20. The deformation light-emitting portion 20 does not emit light before deformation, and emits light after deformation. Alternatively, the deformation light-emitting portion 20 emits light of a color before deformation, and emits light of another color after deformation.

It is to be noted that, first, the pressing surface of the pressing portion 10 is not limited, and the pressing surface may be a complete surface, or a surface composed of a plurality of mutually separate surfaces.

Second, in order that the deformation light-emitting portion 20 is capable of emitting light when any position of the pressing surface of the pressing portion 10 is pressed, in one embodiment, the deformation light-emitting portion 20 completely covers the pressing portion 10 in a direction perpendicular to the pressing direction.

Third, the press feedback in the embodiment of the present disclosure is fed back by an optical signal. Here, when the pressing surface of the pressing portion 10 is pressed, the deformation light-emitting portion 20 contacting the pressing portion 10 may be deformed. Only when the deformation reaches a certain degree, the deformation light-emitting portion 20 will emit light (in case that the deformation light-emitting portion 20 does not emit light before deformation) or emit light of a changed color (in case that the deformation light-emitting portion 20 emits light of a color before deformation, and emits light of another color after deformation).

Fourth, the pressing portion 10 and the deformation light-emitting portion 20 may contact each other directly, or may not contact each other, as long as the pressure subjected by the pressing portion 10 can be transferred to the deformation light-emitting portion 20.

Fifth, the pressing feedback device may include only one deformation light-emitting portion 20, or may also include a plurality of deformation light-emitting portions 20. When the pressing feedback device includes a plurality of deformation light-emitting portions 20, the number of the deformation light-emitting portions 20 is not limited, and may be arranged as needed.

An embodiment of the present disclosure provides a pressing feedback device. Since the pressing feedback device includes a deformation light-emitting portion 20, and the deformation light-emitting portion 20 may be deformed when being pressed, and may emit light (in case that the deformation light-emitting portion 20 does not emit light before deformation) or emit light of a changed color (in case that the deformation light-emitting portion 20 emits light of a color before deformation, and emits light of another color after deformation), the deformation light-emitting portion 20 can perform optical signal feedback when the user presses the pressing portion 10 of the pressing feedback device, such that the user can feel the pressing feedback effect more intuitively, thereby enhancing the experience of the human-computer interaction. Compared with voice feedback and vibration feedback in the prior art, optical feedback is applicable in quiet and noisy occasions.

In one embodiment, as shown in FIGS. 1 and 2, the deformation light-emitting portion 20 includes a pressure-induced luminescent color-change layer.

Here, a pressure-induced luminescent color-change material refers to a kind of intelligent materials of which the luminous color changes significantly under the action of an external force (such as pressure, shear or tensile force, etc.). The reason why the luminescent color of the pressure-induced luminescent color-change material changes is that the crystalline structure of the pressure-induced luminescent color-change material is destroyed. For example, a colorless polymer containing spiropyran structure, when subjected to a pressure, is converted into a polymer containing merocyanine structure, and it emits a colorless light before being applied with pressure and emits red light upon the application of pressure. Since the molecular structure of the pressure-induced luminescent color-change material does not have groups having large steric hindrance, the damaged crystal structure is easily and automatically restored, such that the discoloration (or color change) of the pressure-induced luminescent color-change material is reversible in a short time. Based on this, when the deformation light-emitting portion 20 of the embodiments of the present disclosure includes a pressure-induced luminescent color-change layer, the color of the light emitted from the deformation light-emitting portion 20 changes when the deformation light-emitting portion 20 is subjected to a pressure, and the color of the light emitted from the deformation light-emitting portion 20 may return to the original color before being subjected to the pressure when the pressure is relieved.

The material of the pressure-induced luminescent color-change layer is not limited here. For example, it may be divinyl anthracene-based PAIE (piezfluorochromic aggregation-induced) emission materials, which emit green light before being subjected to pressure, and emit red light upon being subjected to pressure; tetraphenyethylene-based PAIE compounds, which emit blue light before being subjected to pressure, and emit green light upon being subjected to pressure; dicyano compounds, which emit orange light before being subjected to pressure, and emit bright red light upon being subjected to pressure; and hydroxyl substituted tetraphenyl butadiene PAIE compounds, which emit blue light before being subjected to pressure, and emit yellow and green light upon being subjected to pressure. The pressure-induced luminescent color-change materials listed as above are some compounds which emit fluorescent light under pressure. Of course, there are many metal complexes with phosphorescence properties, which, when being subjected to pressure, can cause significant redshift of the emitted light, which are not enumerated here.

It is to be noted that the color of the light emitted from the pressure-induced luminescent color-change material may change only under a certain pressure. When the pressure-induced luminescent color-change materials are different, the pressures required for the luminous discoloration thereof are also different. The pressures required for the luminous discoloration of the general pressure-induced luminescent color-change materials are generally within 3 MPa and 30 MPa. When the pressure on the pressure-induced luminescent color-change layer is constant, if the area subjected to the pressure is smaller, the pressure on the pressure-induced luminescent color-change layer is greater. Thus, the minimum luminescent discoloration pressure of the pressure-induced luminescent color-change layer can be set according to the material of the pressure-induced luminescent color-change layer and the shape of the pressure-induced luminescent color-change layer.

For example, as shown in FIGS. 1 and 2, if the materials of the pressure-induced luminescent color-change layers are the same, the minimum pressures required for the luminescent discoloration of the pressure-induced luminescent color-change layers are the same. When the pressing portion 10 is pressed, since the pressed area of the deformation light-emitting portion 20 shown in FIG. 1 is greater than the pressed area of the deformation light-emitting portion 20 shown in FIG. 2, the applied pressure required for the luminescent discoloration of the pressure-induced luminescent color-change layer shown in FIG. 1 is greater than the applied pressure required for the luminescent discoloration of the pressure-induced luminescent color-change layer shown in FIG. 2. Therefore, the minimum luminescent discoloration pressure of the pressure-induced luminescent color-change layer can be increased or decreased by changing the pressed area of the pressure-induced luminescent color-change layer.

In an embodiment of the present disclosure, since the deformation light-emitting portion 20 includes a pressure-induced luminescent color-change layer, and the pressure-induced luminescent color-change layer emits light of a color before being pressed and emits light of another color upon being pressed, an optical signal can be fed when the deformation light-emitting portion 20 is under pressure.

In one embodiment, as shown in FIG. 3, the deformation light-emitting portion 20 includes a capacitor unit 201, an electroluminescent layer 202 and a control unit 203. The capacitor unit 201 includes a first electrode 2011, a deformation material layer 2012 and a second electrode 2013 stacked in a direction of the pressing. The control unit 203 is connected with the first electrode 2011, the second electrode 2013 and the electroluminescent layer 202, configured to supply a driving signal to the first electrode 2011, and outputs an induced signal of the second electrode 2013 to the electroluminescent layer 202. The capacitor unit 201 is disposed to be corresponding to the electroluminescent layer 202 in the direction of the pressing.

As shown in FIG. 3, the deformation material layer 2012 may be a layer disposed between the first electrode 2011 and the second electrode 2012. Alternatively, the deformation material layer 2012 may be only disposed at two sides of the first electrode 2011 and the second electrode 2012 (not shown in the drawings of the embodiments of the present disclosure).

Here, when the deformation material layer 2012 is under pressure, the shape thereof may change, and immediately return to the original state when the external pressure is removed. The material of the deformation material layer 2012 is not limited, and may be, for example, a urethane-based polymer.

It is to be noted that the electroluminescent layer 202 does not emit light before an electrical signal is applied thereto, and emits light when the electrical signal is applied thereto. The material of the electroluminescent layer 202 is not limited as long as it can emit light when an electrical signal is applied thereto. For example, it may be an organic electroluminescent material, or an inorganic electroluminescent material.

Based on this, the capacitor unit 201 is disposed to be corresponding to the electroluminescent layer 202, and it is ensured that the electroluminescent layer 202 at a position where the pressure is applied may emit light when the capacitor unit 201 is under pressure and the pressure reaches a certain value.

In an embodiment of the present disclosure, when the deformation light-emitting portion 20 is under pressure, a distance between the first electrode 2011 and the second electrode 2013 may change, such that a capacitance between the first electrode 2011 and the second electrode 2013 changes. Since the control unit 203 constantly supplies a driving signal to the first electrode 2011, when the pressure subjected by the deformation light-emitting portion 20 reaches a certain value, that is, the capacitance between the first electrode 2011 and the second electrode 2013 reaches a certain value, the control unit 203 can control the second electrode 2013 to output the induced signal to the electroluminescent layer 202, causing the electroluminescent layer 202 to emit light for optical signal feedback.

In one embodiment, as shown in FIG. 3, the deformation light-emitting portion 20 includes a capacitor unit 201, an electroluminescent layer 202 and a control unit 203. The capacitor unit 201 includes a first electrode 2011, a deformation material layer 2012 and a second electrode 2013 stacked in a direction of the pressing. The control unit 203 is connected with the first electrode 2011, the second electrode 2013 and the electroluminescent layer 202. The control unit 203 is configured to input a driving signal to the electroluminescent layer 202 when it is detected that a voltage value between the first electrode 2011 and the second electrode 2013 of the capacitor unit 201 is changed to a predetermined voltage value after charging of the capacitor unit 201 is finished. The capacitor unit 201 is disposed to be corresponding to the electroluminescent layer 202 in the direction of the pressing.

Here, the capacitor unit 201 may be charged by the control unit 203, or the capacitor unit 201 may be charged by other units, which is not limited here. Moreover, the capacitor unit 201 can be charged by frame.

The predetermined voltage value stored in the control unit 203 is not limited here, and can be set as needed. Based on this, in case that the charges carried by the first electrode 2011 and the second electrode 2013 are constant, when the distance between the first electrode 2011 and the second electrode 2013 changes, the voltage between the first electrode 2011 and the second electrode 2013 will change. Therefore, the amplitude of the voltage between the first electrode 2011 and the second electrode 2013 is related to the pressure subjected by the capacitor unit 201, that is, the greater the pressure subjected by the capacitor unit 201 is, the smaller the voltage between the first electrode 2011 and the second electrode 2013 is.

In an embodiment of the present disclosure, after the capacitor unit 201 is charged, the capacitor unit 201 will store a certain amount of charges. When the deformation light-emitting portion 20 is under pressure, the capacitance of the capacitor unit 201 may increase, and the voltage between the first electrode 2011 and the second electrode 2013 is reduced. When the voltage between the first electrode 2011 and the second electrode 2013 changes to the predetermined voltage value, the control unit 203 may input the driving signal to the electroluminescent layer 202, causing the electroluminescent layer 202 to emit light for optical signal feedback.

In one embodiment, as shown in FIGS. 4A, 4B and 4C, the pressing feedback device includes a plurality of deformation light-emitting portions 20.

As shown in FIGS. 4A, and 4C, one pressing portion 10 may be disposed on the plurality of the deformation light-emitting portions 20. Alternatively, as shown in FIG. 4B, one pressing portion 10 is disposed on each of the plurality of the deformation light-emitting portions 20.

The number of the deformation light-emitting portions 20 included in the pressing feedback device is not limited here, and may be set as needed. If the number of the deformation light-emitting portions 20 is greater, the pressed area of the deformation light-emitting portions 20 increases, such that the force required for the deformation light-emitting portions 20 to emit light will be greater. For example, as shown in FIGS. 4A and 4C, in case that the numbers of the deformation light-emitting portions 20 are the same, since the pressed area of the deformation light-emitting portions 20 in FIG. 4A is greater than the pressed area of the deformation light-emitting portions 20 in FIG. 4C, the pressure required for the deformation light-emitting portions 20 in FIG. 4A to emit light (in case that the deformation light-emitting portions 20 does not emit light before being applied with pressure) or the pressure required for the emitted light to change (in case that the emitted light has a color before being applied with pressure, and has another color upon application of pressure) is greater than the pressure required for the deformation light-emitting portions 20 in FIG. 4C to emit light (in case that the deformation light-emitting portions 20 does not emit light before being applied with pressure) or the pressure required for the emitted light to change (the emitted light has a color before being applied with pressure, and has another color upon application of pressure).

In case that the deformation light-emitting portion 20 includes a pressure-induced luminescent color-change layer, if the pressing feedback device includes one deformation light-emitting portion 20, when the pressing portion 10 is pressed, the pressure-induced luminescent color-change layer which is immediately corresponding to the pressed position may be subjected to the pressure such that the color of the emitted light changes, and the position around the pressed position is also affected by the pressure subjected by the pressed position such that the color of the light emitted from the pressure-induced luminescent color-change layer corresponding to the position around the pressed position may also change. In case that the deformation light-emitting portion 20 includes the capacitor unit 201, the electroluminescent layer 202 and the control unit 203, if the pressing feedback device includes one deformation light-emitting portion 20, when the pressing portion 10 is pressed, the control unit 203 may output the signal to the electroluminescent layer 202 regardless of the change of the capacitance at any position of the capacitor unit 201 due to the pressure, causing the entire electroluminescent layer 202 to emit light.

Based on the above, the pressing feedback device of an embodiment of the present disclosure includes a plurality of deformation light-emitting portions 20, such that only the deformation light-emitting portion 20 corresponding to the pressed position can be precisely controlled to perform optical feedback when being pressed.

In one embodiment, as shown in FIGS. 4A, 4B and 4C, an area of the top of the deformation light-emitting portion 20 is smaller than an area of the bottom of the deformation light-emitting portion 20. The top of the deformation light-emitting portion 20 is an end contacting the pressing portion 10.

In an embodiment of the present disclosure, the area of the top of the deformation light-emitting portion 20 is smaller than the area of the bottom of the deformation light-emitting portion 20, that is, the end of the deformation light-emitting portion 20 contacting the pressing portion 10 is relatively smaller. When the magnitude of the pressure applied to the deformation light-emitting portion 20 is the same, the pressure subjected by unit area is greater in case that the area is smaller. Thus when a smaller pressure is applied, the deformation light-emitting portion 20 may be deformed.

An embodiment of the present disclosure provides a display device including the pressing feedback device described as above.

The display device may be a liquid crystal display device, or may be an OLED (organic light-emitting diode) display device.

The disposed position of the pressing feedback device in the display device is not limited. The pressing feedback device may be disposed in a position of a function key of the display device. When the display device is a touch display device, the pressing feedback device may also be disposed in a display region of the display device.

An embodiment of the present disclosure provides a display device including the pressing feedback device. Since the pressing feedback device includes a deformation light-emitting portion 20, and the deformation light-emitting portion 20 may be deformed when being pressed, and may emit light (in case that the deformation light-emitting portion 20 does not emit light before deformation) or emit light of a changed color (in case that the deformation light-emitting portion 20 emits light of a color before deformation, and emits light of another color after deformation), the deformation light-emitting portion 20 can perform optical signal feedback when the user presses the pressing portion 10, such that the user can feel the pressing feedback effect more intuitively, thereby enhancing the experience of the human-computer interaction. Compared with the prior art in which voice feedback and vibration feedback are configured in the display device, optical feedback is applicable in quiet and noisy occasions.

In one embodiment, as shown in FIG. 5, the pressing feedback device is disposed in a position corresponding to a function key 30 of the display device.

The function key 30 of the display device is not limited, and FIG. 5 schematically shows that the display device is a cell phone. The function key 30 may be a volume key, a power key, a camera key, a confirmation key, a home key or a return key.

Moreover, when the display device includes a plurality of function keys, different colors of optical signal feedback may be conducted for different function keys 30. For example, a red light signal feedback may be responded to pressing the home key, a blue light signal feedback may be responded to pressing the return key, a yellow light signal feedback may be responded to pressing the confirmation key, an orange light signal feedback may be responded to pressing the volume key for increasing the volume, a green light signal feedback may be responded to pressing the volume key for reducing the volume, and a purple light signal feedback may be responded to pressing the power key.

Based on this, the pressing feedback device may be disposed under the function key 30, or disposed above the function key 30. In case that the pressing feedback device is disposed under the function key 30, when the pressing feedback device is under pressure, the light emitted from the pressing feedback device can be radiated out from the periphery of the function key 30, or the light emitted from the pressing feedback device can be radiated out through the function key 30 when the function key 30 is transparent.

Compared with the case that the deformation light-emitting portion 20 of the pressing feedback device includes the capacitor unit 201, the electroluminescent layer 202 and the control unit 203, when the deformation light-emitting portion 20 only includes a pressure-induced luminescent color-change layer, the pressing feedback device has a more simple structure. Thus, preferably, the deformation light-emitting portion 20 of the pressing feedback device disposed at a position corresponding to the function key 30 includes a pressure-induced luminescent color-change layer. Based on this, since the color of the light emitted from the pressure-induced luminescent color-change layer may change only at a certain pressure, the luminous color of the deformation light-emitting portion 20 of the pressing feedback device does not change when the function key 30 is touched accidentally.

In an embodiment of the present disclosure, the pressing feedback device is disposed at a position of the function key 30 of the display device, such that the optical signal feedback of pressing the function key 30 can be achieved when the function key 30 is pressed.

In one embodiment, the pressing portion 10 of the pressing feedback device includes a key-press layer.

In an embodiment of the present disclosure, the key-press layer at a position corresponding to the function key 30 functions as the pressing portion 10 of the pressing feedback device, which not only can reduce the thickness of the display device, but also can simplify the structure of the display device.

In one embodiment, as shown in FIG. 5, the display device is a touch display device, and the pressing feedback device is disposed in a display region 40 of the touch display device.

In an embodiment of the present disclosure, when the pressing feedback device includes the capacitor unit 201, the electroluminescent layer 202 and the control unit 203, the electroluminescent layer 202 does not emit light before being pressed, and emits light only when being pressed. When the pressing feedback device includes a pressure-induced luminescent color-change layer, the pressure-induced luminescent color-change layer emits light of a color before being pressed, and emits light of another color when being pressed. In order to avoid the effect of the pressing feedback device on a normal display of the touch display device, in an embodiment of the present disclosure, the pressing feedback device disposed in the display region 40 of the touch display device includes the capacitor unit 201, the electroluminescent layer 202 and the control unit 203.

Based on the above, in order that the optical feedback is conducted only at the pressed position when the touch display device is pressed, when the pressing feedback device includes the capacitor unit 201, the electroluminescent layer 202 and the control unit 203, it is preferred that the pressing feedback device disposed in the display region 40 of the touch display device includes a plurality of deformation light-emitting portions 20.

The entire display region of the touch display device may be provided with the pressing feedback device, or a part of the display region is provided with the pressing feedback device. In case that the entire display region of the touch display device is provided with the pressing feedback device, when different regions of the display region 40 are pressed, the colors of the fed optical signal may be the same, or may also be different.

The pressing feedback device is disposed in the display region 40 of the touch display device, which should not affect the normal display of the touch display device. It is to be noted that, in case that the pressing feedback device is disposed in the display region 40 of the touch display device, when the display region 40 displays an image, the optical signal feedback is conducted at the pressed position when the display region 40 is pressed. If the deformation light-emitting portion 20 emits light of a color, the light of the color emitted from the deformation light-emitting portion 20 may cause a color displayed at the pressed position to change. Thus when pressing is conducted, the color (such as yellowish, bluish, violet, etc.) displayed at the pressed region may be somewhat different from the color displayed at the region which is not pressed, but the normal display of the display device is not affected.

Here, whether any one icon of the display region 40 is pressed to realize the corresponding function, or the display region 40 is slid to be flipped, as long as the display region 40 is pressed, the corresponding optical feedback may be conducted at the pressed position, such that the human-computer interaction may be conducted, and confirmation information is fed to the user, increasing the user's interest. For example, the user will press the WeChat icon to start the WeChat, and when the WeChat icon is pressed, an optical feedback will be conducted at the position corresponding to the WeChat icon. Or, when browsing the news, the display region 40 is slid to move the page up, and in this case, an optical feedback will be conducted at the slid position. Of course, it may be also applied in a game scene. For example, when a certain position in the game interface is pressed, light may be emitted at such position (in case that light is not emitted before the pressing) or the color of the emitted light changes (in case that light of a color is emitted before the pressing, and light of another color is emitted after the pressing), that is, the optical signal feedback can be conducted, which may be corresponding to the game screen points. Or, a certain region is slid, and such region may be used as a route of a game character, thus it can be applied in shooting, adventure and other action games, increasing the human-computer interaction.

In an embodiment of the present disclosure, the display region 40 of the touch display device is provided with the pressing feedback device, thus when the user presses the display region 40, light may be emitted at the pressed position (in case that light is not emitted before the pressing) or the color of the emitted light changes (in case that light of a color is emitted before the pressing, and light of another color is emitted after the pressing), such that an optical feedback to the user is conducted.

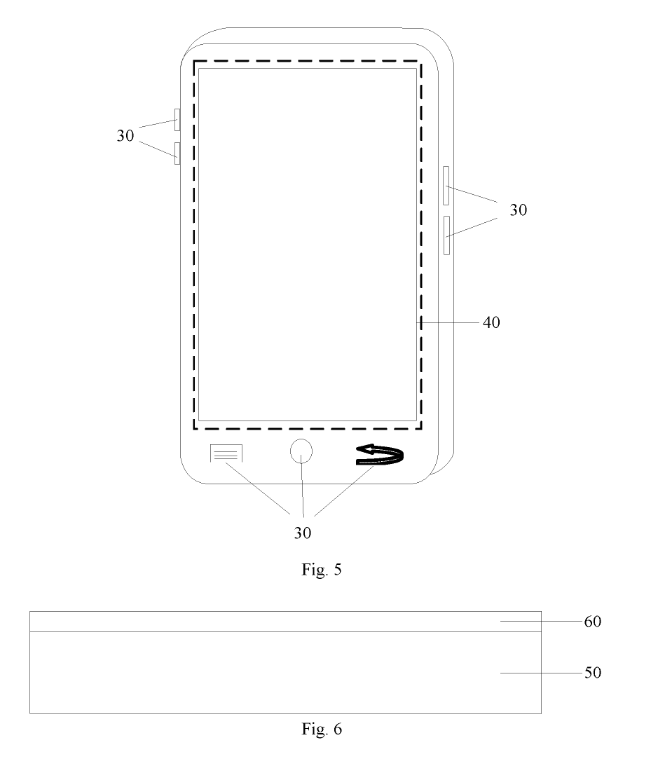

In one embodiment, as shown in FIG. 6, the touch display device includes a touch display panel 50 and a cover plate 60 disposed on the touch display panel 50. When the deformation light-emitting portion 20 includes a pressure-induced color-change layer, the pressure-induced color-change layer is disposed within the touch display panel 50 or between the touch display panel 50 and the cover plate 60. When the deformation light-emitting portion 20 includes the capacitor unit 201 and the electroluminescent layer 202, the capacitor unit 201 and/or the electroluminescent layer 202 is disposed within the touch display panel 50 or between the touch display panel 50 and the cover plate 60. Here, the pressing portion 10 of the pressing feedback device is a part disposed above the deformation light-emitting portion 20, and the part includes the cover plate 60.

When the deformation light-emitting portion 20 includes the capacitor unit 201 and the electroluminescent layer 202, both of the capacitor unit 201 and the electroluminescent layer 202 may be disposed within the touch display panel 50 or disposed between the touch display panel 50 and the cover plate 60, or one of the capacitor unit 201 and the electroluminescent layer 202 is disposed within the touch display panel 50, and the other is disposed between the touch display panel 50 and the cover plate 60, which is not limited herein. Moreover, the control unit 203 of the deformation light-emitting portion 20 may disposed at an edge position of the touch display panel 50.

Based on this, regardless of whether the pressure-induced color-change layer or the capacitor unit 201 and the electroluminescent layer 202 are disposed within the touch display panel 50, or are disposed between the touch display panel 50 and the cover plate 60, they can be disposed in a sub-pixel region, or disposed in a pixel defining region for defining sub-pixels.

Here, the part above the deformation light-emitting portion 20 functions as the pressing portion 10, which not only can reduce the thickness of the display device, but also can simplify the manufacturing process of the display device.

In an embodiment of the present disclosure, the deformation light-emitting portion 20 may be disposed within the touch display panel 50 or between the touch display panel 50 and the cover plate 60 according to the structure of the touch display device.

In one embodiment, the pressing feedback device includes a plurality of deformation light-emitting portions 20, and the display region 40 includes a sub-pixel region and a pixel defining region. If the deformation light-emitting portion 20 has a color before deformation, the deformation light-emitting portion 20 is disposed in the sub-pixel region having the same color or the pixel defining region defining the sub-pixel region.

When the display device is a liquid crystal display device, the sub-pixel region refers to a transparent region, and the pixel defining region refers to a non-transparent region. When the display device is an OLED display device, the sub-pixel region refers to a light emitting region, and the pixel defining region refers to a non-emitting region.

As an example, if the color of the deformation light-emitting portion 20 before deformation is blue, the deformation light-emitting portion 20 may be placed in a blue sub-pixel region or a pixel defining region defining the blue sub-pixel region.

In an embodiment of the present disclosure, if the deformation light-emitting portion 20 has a color before deformation, the deformation light-emitting portion 20 is disposed in a sub-pixel region having the same color or a pixel defining region defining the sub-pixel region, which can avoid the cross-color of the deformation light-emitting portion 20 with the sub-pixel due to its own color.

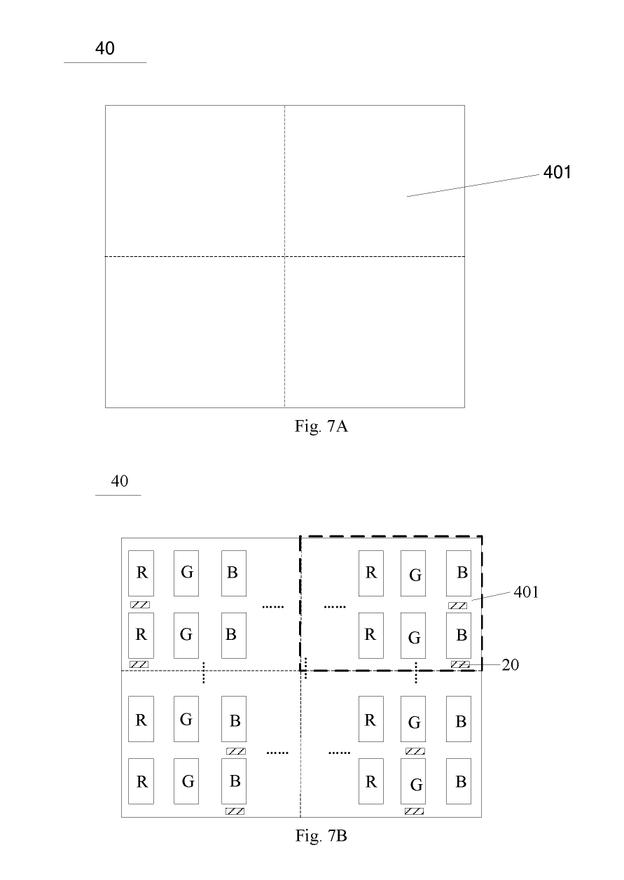

In one embodiment, as shown in FIGS. 7A and 7B, the display region 40 is divided into a plurality of sub-display regions 401, and the pressing feedback device includes a plurality of deformation light-emitting portions 20 disposed in each of the sub-display regions 401. Each deformation light-emitting portion 20 in each of the sub-display regions emits light of the same color after deformation, and at least two of the sub-display regions 401 emit light of different colors after being pressed.

The number of the sub-display regions 401 included in the display region 40 is not limited herein, and the display region 40 may be reasonably divided as needed (FIG. 7 schematically shows that four regions are divided).

Here, each sub-pixel region of each sub-display region 401 or the pixel defining region defining the sub-pixel region may be provided with the deformation light-emitting portion 20, or some sub-pixel regions of each sub-display region 401 or the pixel defining region defining the sub-pixel regions may be provided with the deformation light-emitting portion 20, as long as the normal display of the display device is not affected. In particular, as shown in FIG. 7B, if the deformation light-emitting portion 20 has a color, in the same sub-display region 401, the deformation light-emitting portion 20 may be only disposed in the sub-pixel region having the same color or the pixel defining region defining the sub-pixel region (FIG. 7B schematically shows that it is disposed in the pixel defining region), in order to avoid the cross-color of the deformation light-emitting portion 20 with the sub-pixel due to its own color and to ensure that the same sub-display region 401 emits light of the same color before deformation. If the deformation light-emitting portion 20 is transparent, and does not emit light before deformation, the deformation light-emitting portion 20 may be disposed in each sub-pixel region of the display region 40 or the pixel defining region defining the sub-pixel region (which is not shown in an embodiment of the present disclosure).

In an embodiment of the present disclosure, the display region 40 is divided into a plurality of sub-display regions 401, and at least two sub-display regions 401 emit different colors of light when being pressed. In this case, when the user performs a pressing operation on the display region 40 of the display device, the user feels different optical feedback at the regions where the colors of the light are different when the display region 40 is pressed.

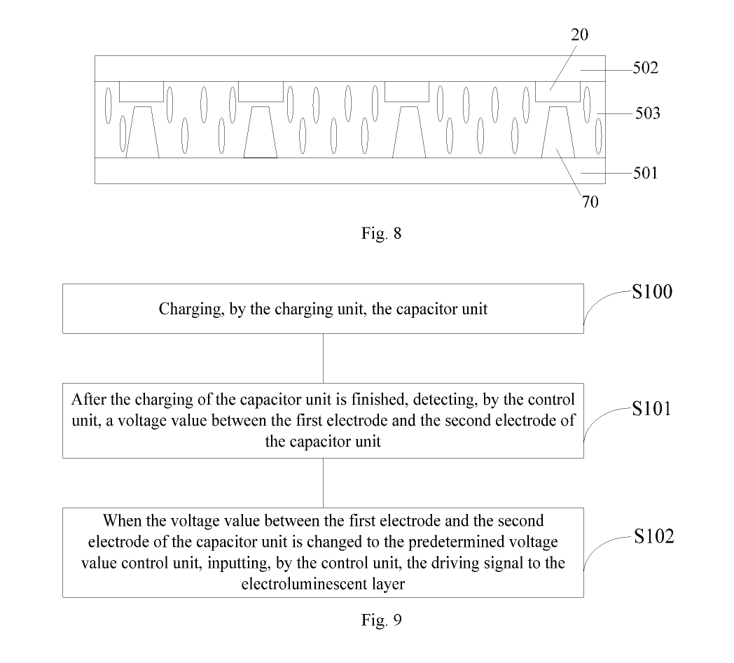

In one embodiment, as shown in FIG. 8, the display device includes a spacer 70. When the deformation light-emitting portion 20 includes a pressure-induced color-change layer, the pressure-induced color-change layer is disposed to be corresponding to the spacer 70. When the deformation light-emitting portion 20 includes the capacitor unit 201 and the electroluminescent layer 202, the capacitor unit 201 is disposed to be corresponding to the spacer 70.

When the display device is a liquid crystal display device, the liquid crystal display panel includes an array substrate 501 and an opposite substrate 502, a spacer 70 may be disposed between the array substrate 501 and the opposite substrate 502, such that a certain gap is maintained between the array substrate 501 and the opposite substrate 502 to fill liquid crystals 503 between the array substrate 501 and the opposite substrate 502.

In an embodiment of the present disclosure, the deformation light-emitting portion 20 is disposed to be corresponding to the spacer 70. On the one hand, the blocking of the light emitted from the display device can be reduced. On the other hand, when the display region 40 is pressed, since the spacer 70 is disposed at the position corresponding to the deformation light-emitting portion 20, the spacer 70 may also apply a pressure to the deformation light-emitting portion 20 when a smaller distance is pressed down, such that the deformation light-emitting portion 20 is deformed. If the deformation light-emitting portion 20 is disposed at a position where the spacer 70 is not disposed, when the display region 40 is pressed, the deformation light-emitting portion 20 may be deformed only when a certain portion of the display device contacts the deformation light-emitting portion 20 and a pressure is applied to the deformation light-emitting portion 20, such that the pressed distance is increased, resulting in an increase in the pressure of downward pressing. Therefore, in an embodiment of the present disclosure, the deformation light-emitting portion 20 is preferably disposed at the position corresponding to the spacer 70.

An embodiment of the present disclosure also provides a driving method of a display device. As shown in FIG. 3, a pressing feedback device of the display device includes the capacitor unit 201, the electroluminescent layer 202 and the control unit 203. As shown in FIG. 9, the driving method includes the following steps.

At step S100, the capacitor unit 201 is charged by a charging unit.

Here, the charging unit may be the control unit 203, and also may be any other unit of the display device.

Here, the capacitor unit 201 is charged by the charging unit by frame, and is not always charged by the capacitor unit 201.

At step S101, after the charging of the capacitor unit 201 is finished, the control unit 203 detects a voltage value between the first electrode 2011 and the second electrode 2013 of the capacitor unit 201.

When the deformation light-emitting portion 20 is under pressure, the distance between the first electrode 2011 and the second electrode 2013 may change, such that the capacitance between the first electrode 2011 and the second electrode 2013 changes. Based on this, after the capacitor unit 201 is charged, the capacitor unit 201 will store a certain amount of charges. When the deformation light-emitting portion 20 is under pressure, the capacitance of the capacitor unit 201 may increase, and the voltage between the first electrode 2011 and the second electrode 2013 is reduced.

At step S102, when the voltage value between the first electrode 2011 and the second electrode 2013 of the capacitor unit 203 is changed to a predetermined voltage value, the control unit 203 inputs a driving signal to the electroluminescent layer 202.

The predetermined voltage value stored in the control unit 203 is not limited herein, and may be set as needed.

An embodiment of the present disclosure provides a driving method of a display device including the pressing feedback device. After the capacitor unit 201 is charged, the capacitor unit 201 will charge a certain amount of charges. When the deformation light-emitting portion 20 is under pressure, the capacitance of the capacitor unit 201 may increase, and the voltage between the first electrode 2011 and the second electrode 2013 is reduced. When the voltage between the first electrode 2011 and the second electrode 2013 is changed to the predetermined voltage value, the control unit 203 may input the driving signal to the electroluminescent layer 202, causing the electroluminescent layer 202 to emit light.

In one embodiment, the display device is a touch display device, and the pressing feedback device is disposed in a display region 40 of the touch display device. The above method further comprises the following step.

When the touch display device is in a locked screen state, the charging unit and the control unit 203 are turned off.

In an embodiment of the present disclosure, since the charging unit and the control unit 203 are turned off when the touch display device is in the locked screen state, the pressing feedback device may not perform the optical feedback in the locked screen state even if the deformation light-emitting portion 20 is pressed.

The foregoing are only specific embodiments of the present disclosure, but the scope of the present disclosure is not limited thereto. Any person skilled in the art will be able to easily think of variations or substitutions within the scope of the present disclosure, which are to be covered within the scope of the present disclosure. Accordingly, the scope of protection of the present disclosure should be based on the scope of the claims.

1. A pressing feedback device, comprising:
a pressing portion having a pressing surface; and
at least one deformation light-emitting portion located under the pressing portion and configured to be deformed under pressing of the pressing portion when the pressing surface is subjected to a pressure, wherein the pressure to which the pressing portion is subjected can be transferred to the deformation light-emitting portion,
wherein the deformation light-emitting portion does not emit light before deformation, and emits light after deformation.

2. The pressing feedback device of claim 1, wherein the deformation light-emitting portion comprises a capacitor unit, an electroluminescent layer and a control unit,
the capacitor unit comprises a first electrode, a deformation material layer and a second electrode which are stacked in a direction of the pressing, and
the control unit is connected with the first electrode, the second electrode and the electroluminescent layer, and is configured to supply a driving signal to the first electrode and to output an induced signal of the second electrode to the electroluminescent layer,
wherein the capacitor unit is disposed to be corresponding to the electroluminescent layer in the direction of the pressing.

3. The pressing feedback device of claim 1, wherein the deformation light-emitting portion comprises a capacitor unit, an electroluminescent layer and a control unit,
the capacitor unit comprises a first electrode, a deformation material layer and a second electrode which are stacked in a direction of the pressing, and
the control unit is connected with the first electrode, the second electrode and the electroluminescent layer, and the control unit is configured to input a driving signal to the electroluminescent layer when it is detected that a voltage value between the first electrode and the second electrode of the capacitor unit is changed to a predetermined voltage value after charging of the capacitor unit is finished,
wherein the capacitor unit is disposed to be corresponding to the electroluminescent layer in the direction of the pressing.

4. The pressing feedback device of claim 1, wherein an area of a top of the deformation light-emitting portion is smaller than an area of a bottom of the deformation light-emitting portion, the top of the deformation light-emitting portion being a portion of the deformation light-emitting portion contacting the pressing portion.

5. A pressing feedback device, comprising:
a pressing portion having a pressing surface; and
at least one deformation light-emitting portion located under the pressing portion and configured to be deformed under pressing of the pressing portion when the pressing surface is subjected to a pressure, wherein the pressure to which the pressing portion is subjected can be transferred to the deformation light-emitting portion,
wherein the deformation light-emitting portion emits light of a color before deformation, and emits light of another color after deformation.

6. The pressing feedback device of claim 5, wherein the deformation light-emitting portion comprises a pressure-induced luminescent color-change layer.

7. A display device, comprising the pressing feedback device of claim 1.

8. The display device of claim 7, wherein the pressing feedback device is disposed at a position corresponding to a function key of the display device.

9. The display device of claim 8, wherein the pressing portion of the pressing feedback device comprises a key-press layer.

10. The display device of claim 7, wherein the display device is a touch display device, and the pressing feedback device is disposed in a display region of the touch display device.

11. The display device of claim 10, wherein the touch display device comprises a touch display panel and a cover plate disposed on the touch display panel, and
the deformation light-emitting portion comprises a pressure-induced color-change layer disposed within the touch display panel or between the touch display panel and the cover plate,
wherein the pressing portion of the pressing feedback device is a part disposed above the deformation light-emitting portion, the part comprising the cover plate.

12. The display device of claim 10, wherein the touch display device comprises a touch display panel and a cover plate disposed on the touch display panel, and
the deformation light-emitting portion comprises a capacitor unit and an electroluminescent layer, the capacitor unit and/or the electroluminescent layer being disposed within the touch display panel or between the touch display panel and the cover plate,
wherein the pressing portion of the pressing feedback device is a part disposed above the deformation light-emitting portion, the part comprising the cover plate.

13. The display device of claim 10, wherein the pressing feedback device comprises a plurality of the deformation light-emitting portions, and the display region comprises a sub-pixel region and a pixel defining region,
wherein if the deformation light-emitting portion has a color before deformation, the deformation light-emitting portion is disposed in the sub-pixel region having the same color or in the pixel defining region for defining the sub-pixel region.

14. The display device of claim 10, wherein the display region has a plurality of sub-display regions, and the pressing feedback device comprises a plurality of the deformation light-emitting portions positioned in each of the sub-display regions,
the deformation light-emitting portions in each of the sub-display region emit light of the same color after deformation, and at least two of the sub-display regions emit light of different colors when being pressed.

15. The display device of claim 10, further comprising a spacer,
wherein the deformation light-emitting portion comprises a pressure-induced color-change layer corresponding to the spacer.

16. The display device of claim 10, further comprising a spacer,
wherein the deformation light-emitting portion comprises a capacitor unit and an electroluminescent layer, the capacitor unit being corresponding to the spacer.

17. A driving method of a display device comprising the pressing feedback device of claim 3, comprising:
charging, by the charging unit, the capacitor unit;
after the charging of the capacitor unit is finished, detecting, by the control unit, a voltage value between the first electrode and the second electrode of the capacitor unit; and
when the voltage value between the first electrode and the second electrode of the capacitor unit is changed to the predetermined voltage value control unit, inputting, by the control unit, the driving signal to the electroluminescent layer.

18. The driving method of claim 17, wherein the display device is a touch display device, and the pressing feedback device is disposed in a display region of the touch display device, wherein the driving method further comprises:
when the touch display device is in a locked screen state, turning off the charging unit and the control unit.
